(19) United States
(12) Patent Application Publication
(10) Pub. No.: US 2015/0285339 A1
(43) Pub. Date: Oct. 8, 2015

(54) MOTORIZED SERVO DEVICE

(71) Applicant: TRICORE CORPORATION, CHANGHUA COUNTY (TW)

(72) Inventor: Yen-Fu CHEN, CHANGHUA COUNTY (TW)

(21) Appl. No.: 14/454,156

(22) Filed: Aug. 7, 2014

(30) Foreign Application Priority Data
Apr. 7, 2014 (TW) 103205946

(51) Int. Cl. F16H 1/20; H02K 7/116

(52) U.S. Cl. CPC F16H 1/206; H02K 7/116

(57) ABSTRACT

A motorized servo device includes a case, a motor disposed in the case, a rolling bearing, and a gear mechanism. The case has an installing portion. The motor has an output gear located in the installing portion. The rolling bearing has an inner ring fixedly sleeved onto the installing portion, and an outer ring rotatable relative to the inner ring. The gear mechanism has a first gear engaged with the output gear, a second gear coaxially fixed to the first gear, a third gear fixedly sleeved onto the outer ring of the rolling bearing and engaged with the second gear, and a fourth gear coaxially fixed to the third gear. As a result, the gear mechanism has high transmission efficiency and low possibility of gear jamming, and is easily assembled.

### BACKGROUND OF THE INVENTION

1. Field of the Invention

The present invention relates generally to a motorized servo device, which is so called servomotor, and more particularly, to a motorized servo device having a gear mechanism which has high transmission efficiency and low possibility of gear jamming, and is easily assembled.

2. Description of the Related Art

Referring to FIG. 1, a conventional motorized servo device 10 primarily comprises a case 11, a cap 12 which is mounted on the top of the case 11, a motor 13, an angular sensor (not shown) and a circuit board (not shown) which are installed in the case 11, and a gear mechanism 14 and an output shaft 15 which are installed in the cap 12. The gear mechanism 14 is adapted for transmitting the rotational kinetic energy of the motor 13 to the output shaft 15. The angular sensor is adapted for detecting the angular position of the output shaft 15 and sending signals to the circuit board as a reference for controlling the motor 13.

Specifically speaking, the case 11 has an installing portion 112 located above the motor 13 and provided with an opening, and the motor 13 has an output gear 132 located in the installing portion 112. The rotational kinetic energy of the motor 13 is outputted by the output gear 132 and transmitted to the output shaft 15 through first to sixth gears 141-146 of the gear mechanism 14 in order. In the gear mechanism 14, the third gear 143 is coaxially fixed to the fourth gear 144, and the fourth gear 144 is rotatably sleeved onto a rod 16 which is fixed to the case 11 and the cap 12. When the motorized servo device 10 is in operation, the friction between the fourth gear 144 and the rod 16 will waste a certain proportion of the rotational kinetic energy of the motor 13 and even lead the gear mechanism 14 to jam and thereby become unworkable. Besides, the assembly of the gear mechanism 14 is time-consuming.

### SUMMARY OF THE INVENTION

The present invention has been accomplished in view of the above-noted circumstances. It is an objective of the present invention to provide a motorized servo device having a gear mechanism which has high transmission efficiency and low possibility of gear jamming, and is easily assembled.

To attain the above objective, the present invention provides a motorized servo device which comprises a case, a motor disposed in the case, a rolling bearing, and a gear mechanism. The case has an installing portion. The motor has an output gear located in the installing portion. The rolling bearing has an inner ring fixedly sleeved onto the installing portion, and an outer ring rotatable relative to the inner ring. The gear mechanism has a first gear engaged with the output gear, a second gear coaxially fixed to the first gear, a third gear fixedly sleeved onto the outer ring of the rolling bearing and engaged with the second gear, and a fourth gear coaxially fixed to the third gear.

As a result, the third gear and the fourth gear are indirectly and rotatably mounted on the installing portion of the case through the rolling bearing. The friction caused by the rotation of the rolling bearing is relatively lower, thereby bringing relatively lower possibility of gear jamming to the gear mechanism and relatively less waste to the rotational kinetic energy so that the gear mechanism has relatively higher transmission efficiency. Besides, the rolling bearing can be combined with the third and fourth gears before sleeved onto the installing portion, resulting in easy and time-saving assembly so that the assembly of the motorized servo device can be simplified and time-saving.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is a partially cutaway view of a conventional motorized servo device according to a prior art;

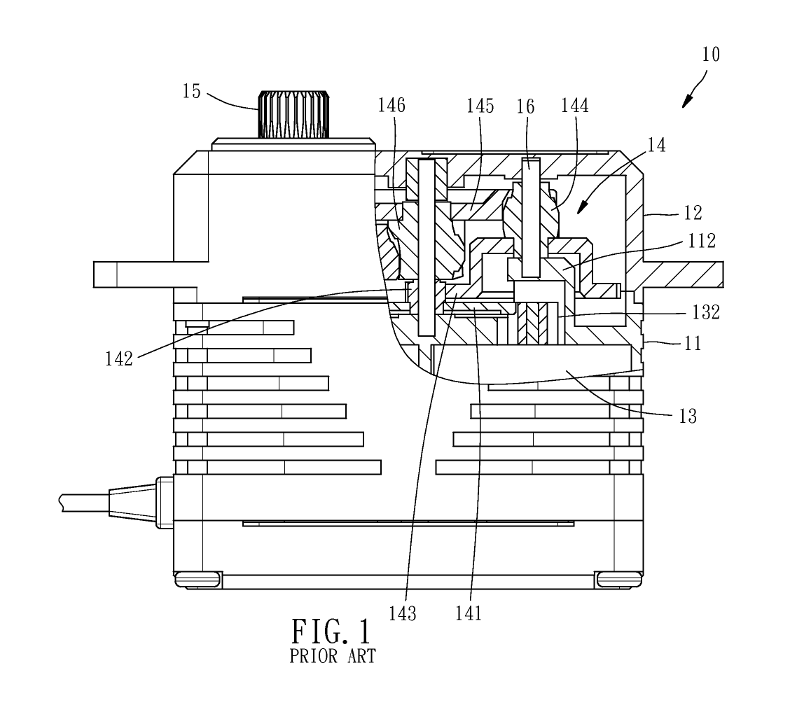

FIG. 2 is an assembled perspective view of a motorized servo device according to a preferred embodiment of the present invention;

FIG. 3 is an exploded perspective view of the motorized servo device according to the preferred embodiment of the present invention; and

FIG. 4 is a partially cutaway view of the motorized servo device according to the preferred embodiment of the present invention.

### DETAILED DESCRIPTION OF THE INVENTION

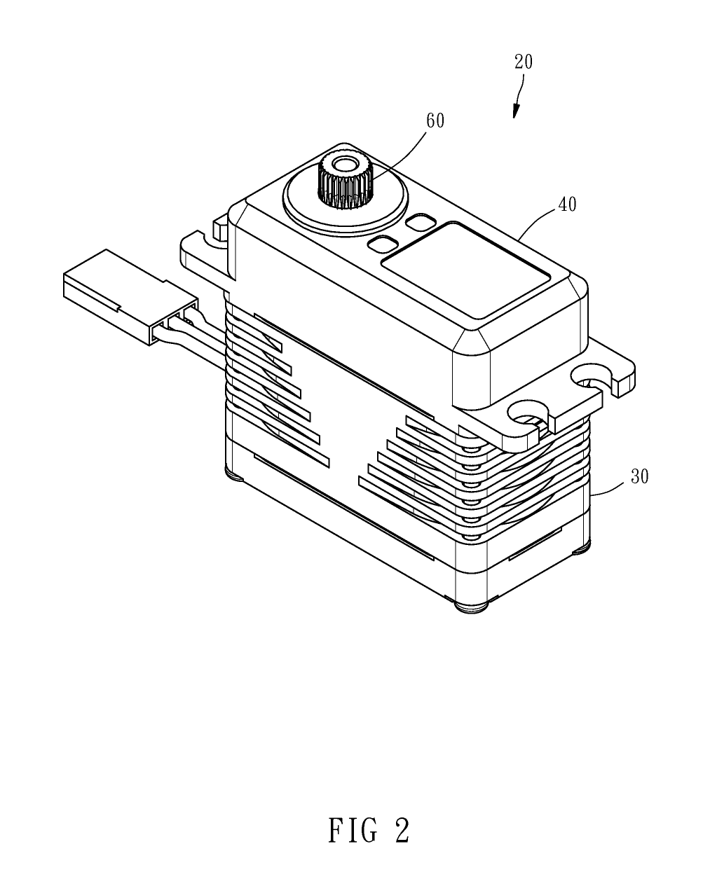

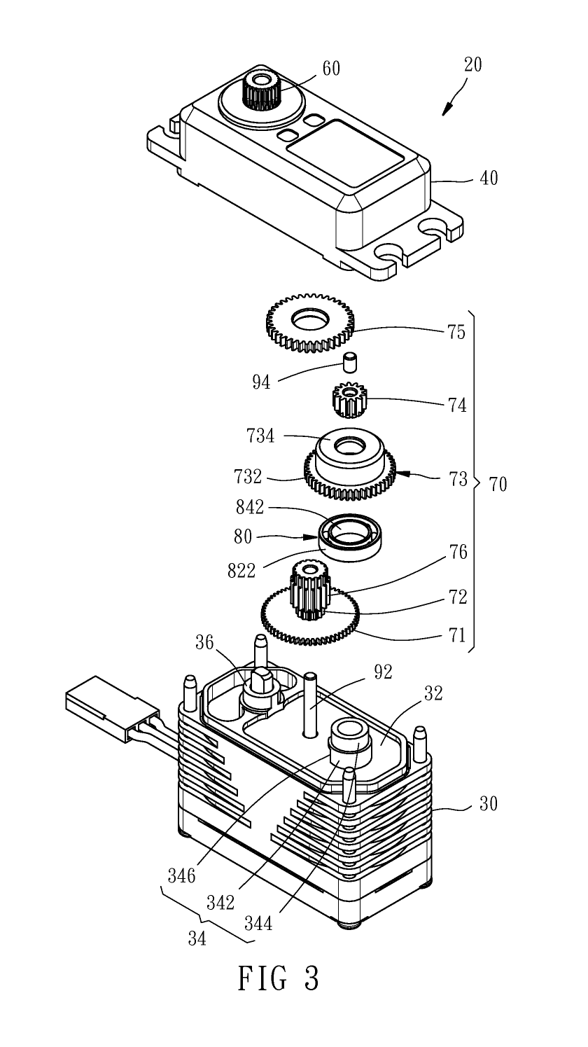

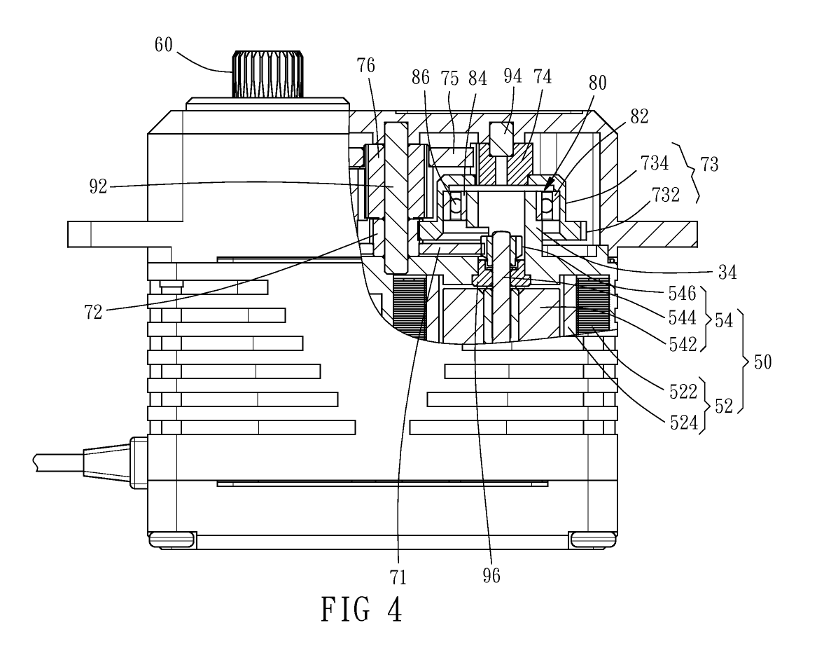

Referring to FIGS. 2-4, a motorized servo device 20 according to a preferred embodiment of the present invention comprises a case 30, a cap 40 which is mounted on the top of the case 30, a motor 50 which is disposed in the case 30, and an output shaft 60, a gear mechanism 70, a rolling bearing 80 and two rods 92, 94 which are disposed in the cap 40. In addition, the motorized servo device 20 further comprises an angular sensor and a circuit board disposed in the case 30, which are not quite related to the improved features of the present invention and thus not shown in the figures.

The case 30 has a top surface 32 and two installing portions 34, 36 protruding from the top surface 32. The motor 50 is disposed in a space located in the case 30 and below the installing portion 34. The output shaft 60 is rotatably sleeved onto the installing portion 36 and protruding out of the cap 40. The angular sensor is disposed in another space located in the case 30 and below the installing portion 36 for detecting the angular position of the output shaft 60 and sending signals about the angular position of the output shaft 60 to the circuit board for controlling the motor 50.

In this embodiment, the installing portion 34 has a large-diameter section 342 connected with the top surface 32, and a small-diameter section 344 connected with the large-diameter section 342. The outer radius of the large-diameter section 342 is larger than the outer radius of the small-diameter section 344. The large-diameter section 342 is provided with an opening 346 facing the installing portion 36. The configuration design of the installing portion 34 is not limited to that having such large-diameter and small-diameter sections 342, 344. However, the installing portion 34 having such large-diameter and small-diameter sections 342, 344 makes the rolling bearing 80 conveniently positioned.

In this embodiment, the motor 50 is a caseless motor which comprises a stator 52 composed of a plurality of annular silicon steel plates 522 and a coil sleeve 524, and a rotator 54 composed of a magnet 542, a spindle 544 and an output gear 546, but doesn't have its own case for accommodating the stator 52 and the rotator 54. The stator 52 and the rotator 54 are directly housed and held by the case 30. The motor 50 is not limited to the caseless motor. However, in the case that the motor 50 is the caseless motor, the motorized servo device 20 will output relatively higher power.

The output gear 546 of the motor 50 is fixedly sleeved onto the spindle 544 and located in the installing portion 34, thereby able to be connected with the gear mechanism 70 through the opening 346 of the installing portion 34. In this embodiment, the spindle 544 of the motor 50 penetrates through an anisotropic bearing 96 which is fixed to the case 30, resulting in low machining difficulty of the case 30 and high stability of the spindle 544. However, the motorized servo device 20 is not limited to have such anisotropic bearing 96.

The gear mechanism 70 comprises first to sixth gears 71-76, wherein the first, second and sixth gears 71, 72, 76 are sleeved onto the rod 92 coaxially. The first gear 71 is engaged with the output gear 546. The second gear 72 is fixed to the first gear 71 for synchronous rotation. The third gear 73 is engaged with the second gear 72. The fourth gear 74 is coaxially fixed to the third gear 73 for synchronous rotation. The fifth gear 75 is engaged with the fourth gear 74. The sixth gear 76 is coaxially fixed to the fifth gear 75 for synchronous rotation. In this way, the rotational kinetic energy of the motor 50 is outputted by the output gear 546 to the gear mechanism 70 and transmitted to the output shaft 60 by the sixth gear 76.

In this embodiment, the rolling bearing 80 is a ball bearing which has an outer ring 82, an inner ring 84, and a plurality of balls 86 installed between the outer ring 82 and the inner ring 84. The outer ring 82 is rotatable relative to the inner ring 84.

The contact between each ball 86 and the outer and inner rings 82, 84 is point contact, thereby causing very low friction. However, the rolling bearing 80 is not limited to ball bearing, but can be other kinds of rolling bearings having the feature of point contact or line contact so as to cause low friction, such as a cylindrical roller bearing, a needle roller bearing, and so on.

In the aforesaid gear mechanism 70, the third gear 73 is rotatably and indirectly mounted on the installing portion 34 through the rolling bearing 80. Specifically speaking, the third gear 73 has a gear portion 732 shaped as a regular spur gear, and a sleeve portion 734 shaped as a hollow cylinder with smaller outer radius than the gear portion 732 and integrally connected with the gear portion 732 coaxially. The inner ring 84 of the rolling bearing 80 is fixedly sleeved onto the small-diameter section 344 of the installing portion 34 of the case 30. The sleeve portion 734 of the third gear 73 is fixedly sleeved onto the outer ring 82 of the rolling bearing 80. The outer ring 82 has an outer cylindrical surface 822 that is fixed to the third gear 73 and may, but is not limited to, be provided with embossment so as to be fixed to the third gear 73 relatively firmer. The inner ring 84 has an inner cylindrical surface 842 that is fixed to the installing portion 34 and may, but is not limited to, be provided with embossment so as to be fixed to the installing portion 34 relatively firmer. Besides, the rod 94 is fixed to the cap 40 and coaxially connected with the fourth gear 74 for increasing the stability of the third and fourth gears 73, 74.

In the motorized servo device 20, the third and fourth gears 73, 74 are rotatably and indirectly mounted on the case 30 through the rolling bearing 80, and the friction caused by the rotation of the third and fourth gears 73, 74 is point friction. As to the motorized servo device 10 mentioned in the description of the related art, the friction caused by the rotation of the third and fourth gears 143, 144 is surface friction. Therefore, compared with the conventional motorized servo device 10, the motorized servo device 20 of the present invention has lower friction when the third and fourth gears 73, 74 rotate, resulting in lower possibility of gear jamming, less waste of the rotational kinetic energy and higher transmission efficiency. Besides, the rolling bearing 80 can be combined with the third and fourth gears 73, 74 and the rod 94 before sleeved onto the installing portion 34, resulting in easy and time-saving assembly so that the assembly of the motorized servo device 20 can be simplified and time-saving. In other words, the gear mechanism 70 of the motorized servo device 20 of the present invention has relatively higher transmission efficiency and lower possibility of gear jamming, and is easily assembled.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A motorized servo device comprising:
a case having an installing portion;
a motor disposed in the case and having an output gear located in the installing portion;
a rolling bearing having an inner ring fixedly sleeved onto the installing portion, and an outer ring rotatable relative to the inner ring; and
a gear mechanism having a first gear engaged with the output gear, a second gear coaxially fixed to the first gear, a third gear fixedly sleeved onto the outer ring of the rolling bearing and engaged with the second gear, and a fourth gear coaxially fixed to the third gear.

2. The motorized servo device as claimed in claim 1, further comprising an anisotropic bearing fixed to the case; wherein the motor has a spindle penetrating through the anisotropic bearing, and the output gear is fixedly sleeved onto the spindle.

3. The motorized servo device as claimed in claim 1, wherein the outer ring of the rolling bearing has an outer cylindrical surface fixed to the third gear and provided with embossment.

4. The motorized servo device as claimed in claim 1, wherein the inner ring of the rolling bearing has an inner cylindrical surface fixed to the installing portion and provided with embossment.

5. The motorized servo device as claimed in claim 1, wherein the motor is a caseless motor.

6. The motorized servo device as claimed in claim 1, wherein the installing portion of the case has a large-diameter section and a small-diameter section; an outer radius of the large-diameter section is larger than an outer radius of the small-diameter section; the rolling bearing is sleeved onto the small-diameter section.

7. The motorized servo device as claimed in claim 1, wherein the third gear has a gear portion engaged with the second gear and a sleeve portion integrally connected with the gear portion coaxially; the sleeve portion is sleeved onto the rolling bearing.
